(19) United States
(12) Patent Application Publication
(10) Pub. No.: US 2026/0281178 A1
(43) Pub. Date: Sep. 17, 2026

(54) SCALABLE LEADERSHIP ELECTION IN A MULTI-PROCESSING COMPUTING ENVIRONMENT USING A ZERO-COMPUTE WITNESS

(71) Applicant: Nutanix, Inc., San Jose, CA (US)

(72) Inventors: Anish Jain, Bangalore (IN); Karan Gupta, San Jose, CA (US); Satya Venkata Praveen Pepakayala, Santa Clara, CA (US); Shirish Vijayvargiya, Pune (IN); Vivek Venkatesan, Apex, NC (US)

(73) Assignee: Nutanix, Inc., San Jose, CA (US)

(21) Appl. No.: 19/080,265

(22) Filed: Mar. 14, 2025

(51) Int. Cl. H04L 67/1097; H04L 43/0823; H04L 67/104

(52) U.S. Cl. CPC H04L 67/1097; H04L 43/0823; H04L 67/1051

(57) ABSTRACT

The present disclosure provides approaches for scalable leadership election using a zero-compute witness in a multi-processing computing environment. As provided herein, a zero-compute witness serves to provide for witness functionality without requiring a running witness process at a remote location. In some embodiments, the zero-compute witness is implemented as a data structure stored on cloud storage (e.g., as a cloud storage object) and is writable using conditional write commands such as HTTP conditional writes or compare-and-swap commands (CAS). In some embodiments, the zero-compute witness is initially configured as an empty data structure that is accessible by multiple nodes in the multi-process computing environment. In some embodiments, entries are only added to the zero-compute witness in response to a detection of a failure of the multi-processing computing environment and entries are removed from the zero-compute witness after a failure has been corrected or recovery operations have been completed.

### FIELD

The rise of database systems and their usefulness for collecting, managing, and analyzing data has led to their prevalence in modern society. This disclosure relates to architectures for high-availability multi-processing computing platforms, and more particularly to techniques for scalable leadership election using a zero-compute witness in a multi-cluster computing environment.

### BACKGROUND

Some computing tasks are parallelized such that there is a master (or leader) and one or more slaves (or followers). Often, the software images that are executed by the instance of the leader and the instances of followers is the same image, and the determination as to whether a particular instance is to act as the leader or act as a follower is made on the basis of the existence and/or contents of a status file that is accessed by the image. Under such a scenario, it can happen that a group of instances are deployed (e.g., started up as individual processes or individual threads) and the determination as to which one member of the group becomes the leader is made based on a policy or by the first instance to “come up” and create and/or write a value into the aforementioned status file. The file system serves as a sequencer/arbiter as to which one process or thread from the group becomes the leader. Nodes that do not become the leader are often assigned as followers.

At some point after initial determination of the leader, the leader or follower might “die” (e.g., the thread stops unexpectedly, or the process runs into a segmentation or other fault) or become unreachable (e.g., due to a network connection issue between two sites). This may result in a potential conflict between the recorded identification of the leaders or followers.

Commonly, this is addressed using a witness process that, on an ongoing basis, captures and maintains the leader and follower information and serves as an arbiter when a change is requested and may be used to essentially cast a deciding vote as to which requestor is to be the new leader.

However, such processes increase the complexity for users to deploy multi-processing and multi-site computing environments as they are normally required to be located in a different location from the remainder of the multi-processing computing environments. For example, a common approach to address this is to deploy a virtual machine in a different location that executes one or more witness processes. Unfortunately, this requires that the user either provide multiple deployment locations or buy computing on a cloud computing service, solely to provide a witness process.

What is needed is a technique or techniques to improve over existing approaches that avoid the requirement to bring up and maintain witness processes and remote locations.

### SUMMARY

The present disclosure provides a detailed description of techniques used in systems, methods, and in computer program products for scalable leadership election using a zero-compute witness in a multi-processing computing environment, which techniques advance the relevant technologies to address technological issues with prior approaches. More specifically, the present disclosure provides a detailed description of techniques used in systems, methods, and in computer program products for scalable leadership election using a zero-compute witness in a multi-processing computing environment. As provided herein, a zero-compute witness serves to provide for witness functionality without requiring a running witness process at a remote location. In some embodiments, the zero-compute witness is implemented as a data structure stored on cloud storage (e.g., as a cloud storage object) and is writable using conditional write commands such as HTTP conditional writes or compare-and-swap commands (CAS).

In some embodiments, the zero-compute witness is initially configured as an empty data structure that is accessible by multiple nodes in the multi-process computing environment. In some embodiments, entries are only added to the zero-compute witness in response to a detection of a failure of the multi-processing computing environment and entries are removed from the zero-compute witness after a failure has been corrected or recovery operations have been completed.

The disclosed embodiments advance the relevant technical fields as well as advancing peripheral technical fields, and modify and improve over prior approaches. In particular, the herein-disclosed techniques provide technical solutions that address the technical problems attendant to and in many modern computing deployments where a plurality of processes need to reach a consensus as to leader/follower relationships. Such technical solutions serve to reduce the demand for computer memory, reduce the demand for computer processing power, and reduce the demand for inter-component communication. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of high-performance computing as well as advances in various technical fields related to distributed storage systems.

Further details of aspects, objectives, and advantages of the technological embodiments are described herein and in the following descriptions, drawings, and claims.

### BRIEF DESCRIPTION OF THE DRAWINGS

The drawings described below are for illustration purposes only. The drawings are not intended to limit the scope of the present disclosure.

FIG. 1 depicts an environment having multiple clusters that are connected to each other and to a zero-compute witness according to some embodiments.

FIG. 2 illustrates a flow for scalable leadership election in a multi-processing computing environment using a zero-compute witness according to some embodiments.

FIG. 3 illustrates a flow for configuring or reconfiguration a cluster that uses a zero-compute witness in a multi-processing computing environment according to some embodiments.

FIG. 4 illustrates a flow for monitoring a cluster using a liveness measure check according to some embodiments.

FIG. 5 illustrates a flow for processing failure detections according to some embodiments.

FIG. 6 illustrates a flow for removing entries that are no longer needed from the zero-compute witness according to some embodiments.

FIG. 7 depicts an environment having multiple clusters and virtual machines that are connected to each other and to a zero-compute witness according to some embodiments.

FIGS. 8A-8D depicts an example sequence of events in an environment having multiple clusters and virtual machines that are connected to each other and to a zero-compute witness according to some embodiments.

FIG. 9 continues the illustrate of FIGS. 8A-8D to illustrate a current leader witness registering ownership of the syncRep relationship according to some embodiments.

FIG. 10 continues the illustrate of FIGS. 8A-8D to illustrate a current follower witness registering ownership of the syncRep relationship according to some embodiments.

FIG. 11 illustrates a flow for migrating from one zero-compute witness to another zero-compute witness. according to some embodiments

FIG. 12A depicts a virtualized controller as implemented in the shown virtual machine architecture according to some embodiments.

FIG. 12B depicts a virtualized controller implemented by containerized architecture according to some embodiments.

FIG. 12C depicts a virtualized controller implemented by a daemon-assisted containerized architecture according to some embodiments.

FIG. 12D depicts a distributed virtualization system in a multi-cluster environment according to some embodiments.

### DETAILED DESCRIPTION

Some embodiments of the present disclosure address the problems exhibited in many modern computing deployments where a plurality of processes need to reach a consensus as to leader/follower relationships. Some embodiments are directed to approaches for breaking a tie that does not rely on a witness process by instead leverages a data structure and conditional writes (e.g., HTTP conditional writes or compare-and-swap (CAS) operations). More particularly, disclosed herein and in the accompanying figures are exemplary environments, systems, methods, and computer program products for scalable leadership election using a zero-compute witness in a multi-processing computing environment.

### Overview

In an a priori manner (e.g., before deployment of any processes to perform any jobs) a zero-compute witness is configured at a remote storage location that is accessible for leader and follower management for any process or thread that is/are expected to perform either as a leader or as a follower.

Deployments that have various processes spread out over multiple clusters (e.g., over wide geographic areas) are often interconnected (e.g., over a cloud backbone, or over the internet) such that the various processes make continuous progress in synchronicity, where an agent/leader process or thread sends data to one or more listener/follower processes or threads. If it happens that an agent fails or ceases to communicate with the one or more listener/follower, then the synchronized progress stops and a new agent/leader is needed. In leader-follower scenarios, if it happens that a leader fails or ceases to communicate with the one or more followers, then the synchronized progress stops and a new leader is needed. In some deployments (e.g., clustered deployments) the nodes need to form a majority to form a consensus. However, in some instances it is not possible to form a majority—e.g., where there is one leader and one follower, if either fails the other alone cannot form a majority. An alternative method which is disclosed herein that leverages a zero-compute witness to form a majority such that a new node can become the leader. As disclosed wherein this is generally accomplished using a zero-compute witness comprising a remote storage location that is configured for access prior to a corresponding failure. In some embodiments, the zero-compute witness is not used for leadership election absent a failure and instead comprises an empty data structure in the absence thereof.

To illustrate, architectures that involve deployment of a leader process on one cluster and one or more follower processes on a different cluster sometimes precipitate an unwanted task interaction scenario termed “split brain”. Often, split-brain scenarios exhibit unwanted interactions, especially when sharing data. In scenarios that rely on uninterrupted availability of a leader task, even in high-availability scenarios, intended uninterrupted availability of a leader task can be interrupted (e.g., due to failure of a node or network or due to a cluster-wide outage or cluster-wide disaster). A witness process serves to avoid split-brain conflicts that can precipitate shared data corruption. A witness process resides in a failure domain that is separate from the leader process failure domain.

In certain deployments, a particular process image (e.g., binary image) is constructed (e.g., by a developer) such that the functions of a transmitter (e.g., a block change transmitter agent) as well as the functions of a receiver (e.g., a disaster recovery change listener) are included in the same image. The particular parameters that pertain to the setting (e.g., in a branch deployment or in a remote office deployment) and/or the particular parameters that pertain to respective roles of leader or follower are determined at run-time based, for example, on conditions and/or parameter that are present and/or determined at the time of invocation. A particular process image can be deployed as a task or process or thread, or a virtual machine (VM) or as a container. Further, the topology of nodes or clusters as interconnected by a network can include spoke-and-wheel topologies, mesh topologies, ring topologies, etc.

What is described herein is a zero-compute witness. The figures provide successive disclosure of the concepts involved, including functions of a cluster thus uses a zero-compute witness. Strictly as an overview, the zero-compute witness relies on a preconfigured storage area with a known method of uniquely identifying resources or relationships and identifying a corresponding leader thereof. Such an approach can be used to provided leadership determination among a set of nodes in the event of a failure and comprises a storage area that can be written to using conditional write operations. Generally, one or more node in a deployment attempt to register as a leader upon detection of a failure (e.g., upon detection or determination that the services leader or follower has been lost) using an application programming interface to transmit a conditional write request to the zero-compute witness. In the event of such a failure, the node that successfully writes their leadership registration information to the zero-compute witness becomes the leader. Such conditional write requests comprise attempts to write a particularly-formed key/value pair. However, if such a request fails (e.g., due to the corresponding condition not being met) the requestor will not become the leader.

The approaches provided herein are discussed largely in the context of disaster recovery configurations and more particularly to synchronous replication (syncRep) relationships. Generally, such relationships are configured and survive until the point where a failure occurs. For example, a virtual machine (VM) at a first location might be configured to have a syncRep relationship with a second location. As a result, any changes to the VM at the first location are reproduced at a VM at the second location. If the first location fails, recovery can be accomplished by switching to the VM at the second location but the syncRep relationship is broken as a result of the failure. Subsequently, a new syncRep relationship may be created with the VM at the second location to the recovered or a replacement VM at the first location. However, such a relationship represents a new relationship. As provided herein, such relationships can be manages using a zero-compute witness that, in the event of a failure (of the leader or the follower), can be used to register a single VM as the leader. Additionally, as discussed herein, configuration of the zero-compute witness prior to a failure in combination with a shared set of identifiers, conditional writes, and a known format for a data structure in the zero-compute can be used to enable the cluster to manage leader and follower relationships without creating entries in the zero-compute witness prior to a failure. Thus, in some embodiments, it is only when a failure is detected that the zero-compute witness might be updated to include leadership registration information.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment. An aspect or an advantage described in conjunction with a particular embodiment is not necessarily limited to that embodiment and can be practiced in any other embodiments even if not so illustrated. Also, references throughout this specification to “some embodiments” or “other embodiments” refers to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments.

### Definitions

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### Descriptions of Exemplary Embodiments

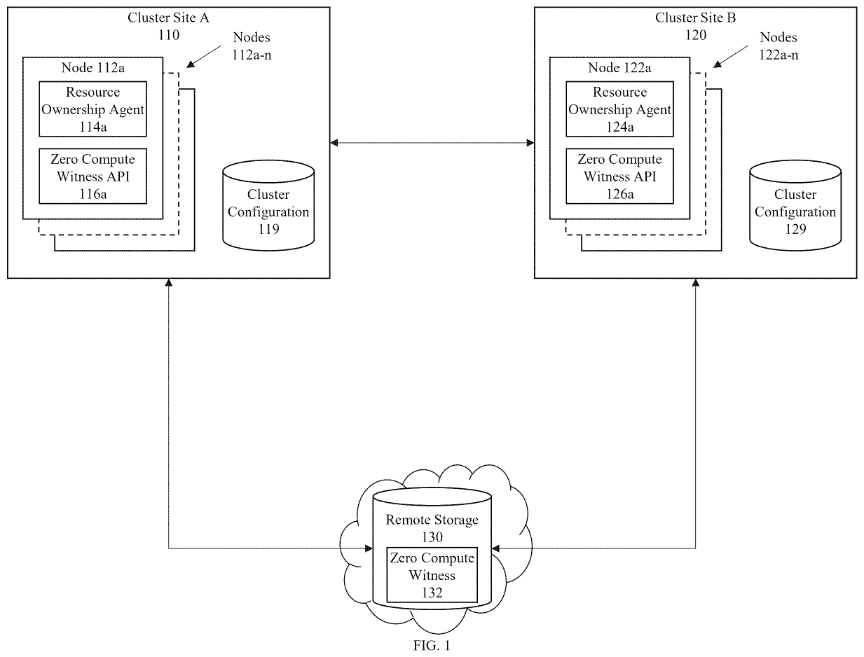

FIG. 1 depicts an environment having multiple clusters that are connected to each other and to a zero-compute witness according to some embodiments. Generally, the environments comprise a first cluster at a first site and a second cluster at a second site that are configured to exchange communications. Additionally, each site includes at least one node that is configured to access a zero-compute witness for leadership election and management of resources that may be shared across the sites. Though not illustrated each node may include one or more processes (e.g., VMs) that may be in a leader or follower relationship with another process at another locations (e.g., a VM at a first cluster site is in a syncRep relationship with a VM at a second cluster site).

As illustrated, a first cluster is provided at site A (see 110) and a second cluster is provided at site B (see 120). Such clusters may be separately managed or may be configured in a stretch cluster arrangement—e.g., to allow for resource sharing and configuration and maintenance of syncRep relationships. Additionally, in order to provide for leadership election in the event of a failure at any one of the sites, a zero-compute witness (132) is provided on remote storage (see 130). Furthermore, while the present illustration includes only one cluster at site A and another cluster at site B, any combination of clusters may be provided at any number of sites which utilize one or more zero-compute witnesses which may be the same or different witnesses. Similarly, while only a single zero-compute witness is illustrated, there may be any number of witnesses provided to a single cluster or stretch cluster. Furthermore, in some embodiments, a zero-compute witness is provided along side a traditional witness process where the zero-compute witness is used for management of a first set of resources and the traditional witness process is used to manage a second set of resources. In some embodiments, the first set of resources correspond to computing resources and the second set of resources correspond to a storage witness or vice-versa. In some embodiments, a single witness can be shared by any number of clusters whether those clusters comprise only compute clusters, storage clusters, or some combination thereof. Generally, and as provided herein, a compute cluster performs general computing tasks, whereas a storage cluster performs storage tasks for storing data. In some embodiments, the compute and storage clusters are provided together (e.g., in a hyperconverged infrastructure).

Generally, a cluster comprises multiple nodes that are each configured in a way to allow for them to interoperate to perform various computing tasks. For instance, in some embodiments, multiple processes may operate on a shared resource (e.g., set of data, volume, volume group). That shared resource may be owned by any one of the multiple processes at any given time but may also be accessible (e.g., for one or more of operations to allow for reading, writing, creation, and deletion) one or more followers. In some embodiments, such access may be utilized by first sending any access requests to the resource owner. In some embodiments, the owner of the resource was elected as the leader or owner of the resource. As provided herein leader and owner are used interchangeably. In some embodiments, a resource may be associated with a synchronous replication relationship (syncRep). For instance, a VM on a node at cluster site A might be associated with a syncRep relationship with a node at cluster site B. At any given time only one node should be the leader or owner of that resource, with the other node being a follower that replicates any changes to the virtual machine (e.g., writes to a corresponding virtual disk). However, a leader or follower may fail at any time or a communication breakdown may occur that results in an inability for one or more sites to send or receive communications to or from the other. In such an instance, a remote zero-compute witness might be accessed to request ownership of the resource as provided herein.

In some embodiments, cluster site A (see 110) includes a plurality of computing nodes (see 112a-n). Each computing node executes one or more processes as provided herein. Such processes may execute containers, applications, or other microservices (e.g., using Docker or Kubernetes) in a virtualization environment (e.g., a container virtualization environment). Additionally, each computing node my include a hypervisor and one or more virtual machines provided thereon that execute processes. In order to provide for leadership election and follower management, node 112a includes a resource ownership agent 114a, a zero-compute witness API 116a, and is able to access a cluster configuration (see 119) which may comprise a shared metadata store or other shared storage facility.

In some embodiments, cluster site B (see 120) also includes a plurality of computing nodes (see 122a-n). Each computing node executes one or more processes as provided herein. Such processes may execute containers, applications, or other microservices (e.g., using Docker or Kubernetes) in a virtualization environment (e.g., a container virtualization environment). Additionally, each computing node my include a hypervisor and one or more virtual machines provided thereon that execute processes. In order to provide for leadership election and follower management, node 122a includes a resource ownership agent 124a, a zero-compute witness API 126a, and may be able to access a cluster configuration (see 129) which may comprise a shared metadata store or other shared storage facility.

As illustrated cluster sites A and B are essentially equivalent. However, even in a stretch cluster arrangement cluster site A and cluster site B will generally differ in at least some regards. For instance, for resources that are shared across both clusters one only node will normally be the owner of any particular resource and any other nodes will normally be follower nodes. Thus, a node at cluster site A may be the leader of a particular resource, while a node at cluster site B might be a follower of that same particular resource. Additionally, cluster site A and B might have access to resources that are not accessible to the other and are therefore not reproduced at the other. In some embodiments, the cluster configurations of one site differ from the other in that configuration information that is only relevant to one cluster will not be duplicated to the other. For example, duplicate entries might be created only for shared resources and for syncRep relationships. Thus, each cluster may include resources and processes that do not appear in the cluster configuration of the other cluster.

A resource ownership agent (see e.g., 114a and 124a) manages the ownership of resources and monitors the corresponding processes associated with those resources. For example, the resource ownership agent accesses a cluster configuration to determine, change, or specify a particular owner of a resource and any followers of that resource. Likewise, the resource ownership agent exchanges communications with one or more other resource ownership agents or nodes to determine which node will be the leader of a resource. In some embodiments, each node includes a resource ownership agent that manages resources owned by one or more processes on that node. In some embodiments, a single node at each site is elected to be the leader for resource management purposes. Furthermore, the resource ownership agent may perform liveness measures for nodes or processes that are represented by the leader or follower relationships identified in the cluster configuration. Generally, as provided herein and in the absence of a failure, resource ownership is managed by the cluster(s) without the use of the zero-compute witness to store corresponding leader and follower information—e.g., during normal operation, the cluster (whether at a single site or across multiple sites) performs and manages leadership election without accessing the zero-compute witness and without storing a corresponding entry in the zero-compute witness. Instead, it is only when a resource ownership agent determines that a liveness measure has fallen outside of a threshold that the zero-compute witness is accessed.

In some embodiment, the zero-compute witness is accessed via a zero-compute witness API (see e.g., 116a and 126a). For example, the zero-compute witness API uses a previously stored set of credentials to access the zero-compute witness using a conditional write operations (e.g., an HTTP conditional write or a compare-and-swap operation). For example, a zero-compute witness having an initial database configuration that comprises a number of fields for storing values to identify a syncRep relationship and identifying a leader and potentially one or more followers. In some embodiments, a zero-compute witness is arranged logically as a tabular structure having rows and columns, where a first field is for storing a key that uniquely identifies a resource and where an additional field is provided for each site with the zero-compute witness supports. As provided herein, the resource ownership agent uses the zero-compute witness API to attempt to write to the zero-compute witness in response to a detection of a failure of a liveness measure check. If that attempt is successful the corresponding cluster will continue to be or become the leader for the corresponding resource while if write fails the cluster will remain or become a follower or will be placed into a depreciated state as the leader follower relationship is likely broken and will need to be repaired.

The remote storage comprises any storage that is normally accessible by any cluster sites that it is to support. For instance, the remotes storage 130 as illustrated here would necessarily need to be accessible to both cluster site A and cluster site B. Such access may be predicated on a handshake or authentication process. For example, the remote storage might be provided by a cloud services provider such as AWS or Azure and the zero-compute witness comprises an AWS bucket or Azure BLOB therein having an object that embodies the zero-compute witness. Such a witness is not a process but is instead a storage area. As provided herein, that storage area is accessible using a conditional write mechanism to avoid one node changing an already established leader. Additionally, as discussed elsewhere herein, entries in the zero-compute witness that are no longer relevant can be removed after recovery from a failure. Any of a variety of information that is passed to and from the zero-compute witness can be stored in a relationship storage area to provide a zero-compute witness in a multi-processing computing environment, such as in a remote office, branch office environment (ROBO) scenario.

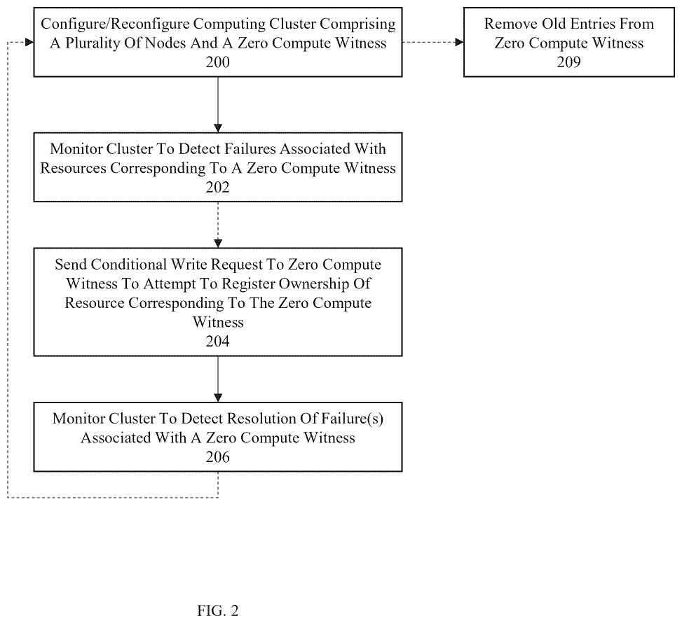

FIG. 2 illustrates a flow for scalable leadership election in a multi-processing computing environment using a zero-compute witness according to some embodiments. Generally, leadership election techniques are well known. These processes present challenges for system designers when dealing with resources shared across multiple sites when a number of participants available at any given time may be insufficient to form a quorum. In order to address this, prior approaches provided at least a witness process that would, on an ongoing basis, implement logic to monitor the leaders and followers of resources, and maintain a set of information that specifies the leaders and followers of resources managed. However, these approaches all require that the witness be a process that implements a set of logic to maintain leader/follower information. As a result, they present a burden to users as those users need to provide a location for the witness that is separate from the cluster(s) they serve. This issue is potentially lessened by the ability to rent computing and storage from cloud providers. However, that approach is still costly. The present approach is contrary to the process-based approach as it does not require a specialized witness process. Instead, the present approach is embodied as easily and cheaply available cloud storage where conditional writes are used to register ownership of a resource using already available access features supported by cloud providers such as HTTP conditional writes and compare-and-swap operations. Furthermore, the present approach can be further used to lower the resource burden by providing an approach that only accesses with cloud storage when a failure is detected.

The process generally starts at 200 where a cluster is configured or reconfigured. For example, a cluster may be configured to include a number resources where respective processes or nodes are assigned to be the leader of those processes. Additionally, in the case of a stretch cluster with disaster recovery capabilities a number of resources might be duplicated from one site to another. For instance, some or all VMs at a first site might have a syncRep relationship created with a second cite or vice versa. Such relationships need to be monitored to avoid split brain scenarios where one process mistakenly takes the leadership role. As provided herein, a zero-compute witness is provided that can assist in managing leader to follower relationships for syncRep relationships and shared resources.

At 202 the cluster is monitored to detect failures associated with resources corresponding to a zero-compute witness. Generally, this comprises at least processes on the cluster exchanging liveness indications and periodic determinations as to whether those liveness indications meet a given liveness threshold. For example, in a stretch cluster arrangement, an agent might be provided at each site to perform liveness measure checks and to create liveness indications. Approaches to perform the liveness measure check are provided elsewhere herein but generally comprise heart beat signals and their equivalents such as regular updates to a shared storage area to indicate a liveness. Such liveness measures may be monitored and absence thereof for greater than a threshold period can be used as an indication that a corresponding process has failed. As provided herein a failure might comprise a literal failure of a process (e.g., the process crashing either directly or as part of a larger failure such as a container on a virtual machine or a virtual machine on a node). Additionally, in some embodiments, a failure may comprise a process that is otherwise still active but is unreachable (e.g., due to a network failure).

In the event that a failure is detected, a conditional write request is sent to the zero-compute witness at 204. Such a write uniquely identifies a resource (e.g., using a unique key) and specifies recording of an entry that registers the requestor as the leader or owner of the resource. Generally, such a request would be processed in the order that it is received. Thus, if multiple processes or clusters (e.g., cluster site A and cluster B) transmits a corresponding conditional write around the same time, a first received request would be successfully processed while any subsequent requests would be rejected due to the condition (that there is not already a leader registered) not being satisfied. In some embodiments, no entry is provided in the zero-compute witness prior to receiving a conditional write request and lack of the existence of an entry having a matching key is used as the condition on which the conditional write request is predicated.

In the event that a failure is detected as discussed at 202, and a leader is registered at 204, a process at 206 executes operations to monitor the cluster to detect resolution of the failure. For example, the cluster might be monitored to detect when a previously failed process has restarted or when communications with a previously unreachable process have been recovered. In response to such a detection the process returns to 200 where the cluster is reconfigured as necessary. For example, the recovered process might be assigned to be a follower when a different process was already assigned to be a leader. Additionally, in the case of a syncRep relationship, a failure is deemed to have broken the previously existing syncRep relationship. A new syncRep relationship might then be created. However, the new relationship would be identified using a different relationship identifier and may correspond to a different leader or owner. For instance, in the case of a VM that was started at a first site (e.g., cluster site A) where a syncRep relationship was created with a second site (e.g., cluster site B), in response to a detection of a failure of the VM at the first site might result in the second site becoming the leader. Subsequently, upon recovery at the first site, the VM at the first site might be configured to be a follower of the VM on the second site using a newly created syncRep relationship. In some embodiments, upon recovery from a failure (e.g., of a syncRep relationship) and the creation of a new syncRep relationship, an entry from the old syncRep relationship is removed from the zero-compute witness (see e.g., 209).

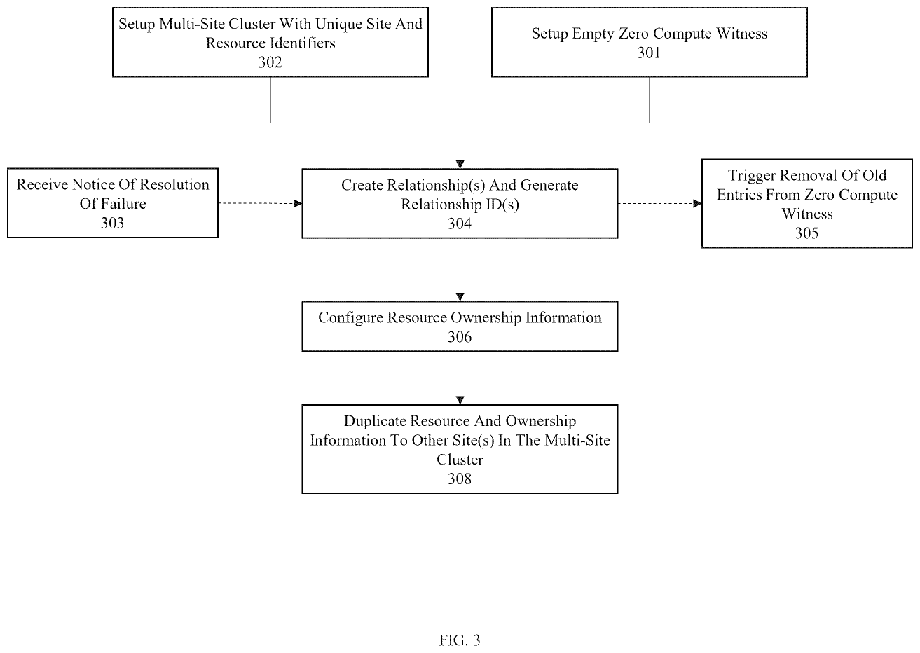

FIG. 3 illustrates a flow for configuring or reconfiguration a cluster that uses a zero-compute witness in a multi-processing computing environment according to some embodiments. Generally, the approach includes setting up a zero-compute witness for use in the event of a failure of a resource to be managed using at least the zero-compute witness. As provided herein, each site or node that is to interact with the zero-compute witness is configured with such a capability prior to the event of a failure.

The process generally starts at 302 where at least unique site and resource identifiers are created. For instance, each site might be given a 64 bit identifier that is unique within a set of cluster sites to be supported by a zero-compute witness. Additionally, each resource is given a unique identifier that can be used to identify the resource. For example, upon the creation or addition of a site to a cluster, a unique identifier is generate using any known technique. Likewise, upon the creation or addition of a resource (e.g., a VM) a unique identifier is generated—e.g., a 64 bit ID is created upon creation on or migration to the cluster.

As illustrated at 301, a zero-compute witness is setup. Such a zero-compute witness is described further herein, but generally comprises a storage area at a remote storage location. For instance, if a cluster comprises a stretch cluster with a first site in Arizona and a second site in South Carolina a zero-compute witness might be created at a cloud service having a datacenter in yet another location (e.g., Colorado). Generally, such a witness might be embodied solely as a storage area that is arranged in a specific data format—e.g., as a table having a specific arrangement of rows and columns. Furthermore, each cluster, site, node, or process that might need to access the zero-compute witness is configured with any necessary authentication information for said access. Various arrangements can be provided that include zero-compute witnesses. For example, a single witness could be provided for a node, cluster, or process. Alternatively multiple witnesses could be provided for a cluster. In some embodiments, a cluster uses both a zero-compute witness along with a witness process and where different domains (e.g., kernel, user, data, compute) rely on different witnesses of the same or different types.

Once identifiers (discussed above in regard to 302) and the zero-compute witness (discussed above in regard to 301) have been configured relationships can be created that rely on the zero-compute witness to help resolve failures at 304. Generally, relationships are identified using unique identifiers or a combination thereof. For instance, a leader follower relationship might be uniquely identified by a concatenation of a resource ID and a relationship ID. Generally, resource ID will uniquely identify the resource. Likewise, a relationship ID uniquely identifies the relationship. For example, a syncRep relationship is created for a VM on a first site with a VM on a second site. Part of this process also includes generation of a unique replication relationship ID. A combination of a replication relationship ID and the resource identifier (ID) for the VM can be used to uniquely identify the VM and corresponding syncRep relationship. In some embodiments, any relationship can be managed in a similar manner provided that a unique relationship ID can be generated. For example, a relationship ID might be identified using a concatenation of a combination of any number of values (e.g., a sequence number, a time of creation, one or more site IDs that are members of the relationship).

At 306 resource ownership information is configured. For example, an entry in a cluster configuration (see e.g., 119) is created that identifies the VM, the replication relationship(s) associated with VM and the leader and follower status for each site. For instance, an entry is generated in the cluster configuration that identifies the resource (e.g., by a unique resource identifier), the replication relationship by the replication relationship identifier, and the leader and any followers for the replication relationship by unique site identifiers. Additionally, at 308, the resource and ownership information is duplicated as warranted to other sites. For example, if a relationship comprises a syncRep relationship between sites A and B, information representing that relationship will be duplicated to the other-e.g., from site A to B or site B to A.

As discussed elsewhere herein, a failure may eventually be resolved. As such an approach is provided herein to update any corresponding syncRep relationships. For example, after receiving a notice of resolution of a failure, a new syncRep relationship might be created at 304. After which the old syncRep relationship can be removed (see e.g., 305). In particular, if a node that included a VM with a syncRep relationship from site A to site B crashes. Upon recovery (e.g., reboot) of that node the old relationship can be removed from the cluster configuration and from the zero-compute witness. Generally, such a relationship would be replaced with a new relationship in the same manner as used to create the prior failed syncRep relationship.

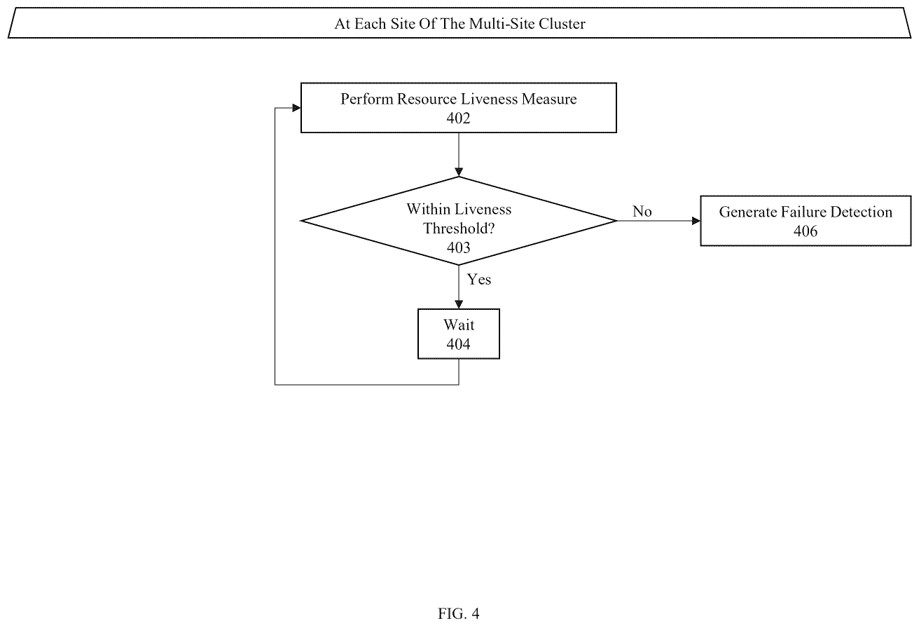

FIG. 4 illustrates a flow for monitoring a cluster using a liveness measure check according to some embodiments. Generally, such an approach is periodic as a liveness measure is usually tied to a number of failures to report liveness or a threshold period of time in which insufficient liveness reports were created. As provided herein, each site of the multi-site cluster includes at least one process or node that performs a liveness measure check. In some embodiments, only a single node or process from each site performs a liveness measure check and the single node or process is selected by the site as a leader for that purpose. In some embodiments, multiple nodes or processes are selected by the site as a leader different zero-compute witnesses. As provided herein, liveness measure checks are performed at each site for each relationship. Specifically, because the zero-compute witness is only utilized in the event of a failure, each site must perform the necessary monitoring to determine whether liveness measures have fallen outside of a threshold because a split-brain scenario where each site is functioning properly but for an inability to exchange communications, without more, might result in the follower registering with the zero-compute witness to become the leader while the current leader is otherwise operational. Thus, even a current leader must also monitor for liveness to then attempt to register its own leadership status with the zero-compute witness, and where failure indicates that the current leader has lost leadership status.

As is known, there are many types of signals that can be used to a liveness measure check and many different ways in which those signals can be processed. For example, a countdown time could be used where the countdown timer is reset each time a heartbeat signal is received. Alternatively, each heartbeat signal received could be used to trigger entry of a time stamp into a log with an identifier indicating the corresponding resource (e.g., resource, relationship, and site identifiers). Another approach might comprise use of a shared storage area, where associated processes write to and read from the share storage to both create liveness indications and to read liveness indicates from other processes. Regardless of the approach used to create the information for the liveness measure check, the liveness measure check applies one or more rules to determine whether a corresponding resource is associated with a failure. Such rules could comprise a threshold applied to a time since a last liveness indication was created or provided, the expiration of a timer, a threshold number of missed liveness indications for a given period of time or any combination thereof. As illustrate here, a liveness measure creates a value at 402 to indicate the liveness. Subsequently, conditional logic is applied to the liveness measure to determine whether the liveness measure is within a threshold at 403.

If the liveness measure falls within the threshold the process may wait (see e.g., 404) for a time (e.g., until a triggering event occurs such as a timer). On the other hand, if the liveness measure is outside of the threshold a failure detection is generated at 406. In some embodiments, all nodes or processes associated with a replication relationship perform liveness process to determine whether one or more relationships are associated with a failure. However, as the witness provided herein is a zero-compute witness, the witness does not participate in performance of liveness measures or checking. Instead, such processes are managed by the corresponding cluster(s).

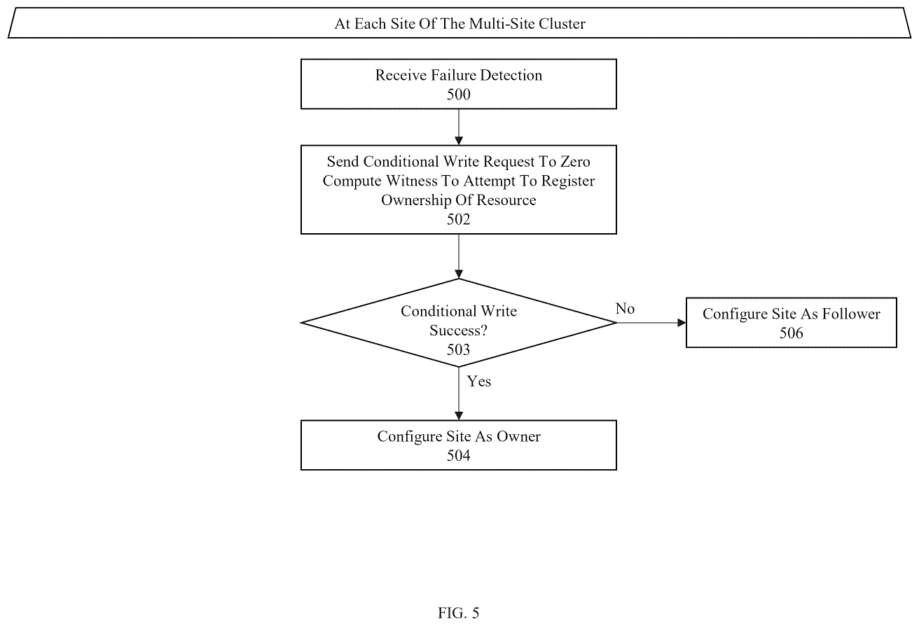

FIG. 5 illustrates a flow for processing failure detections according to some embodiments. Generally, each site of the multi-site cluster includes at least one process or node that processes failure detections. In some embodiments, only a single node or process from each site processes failure detections and the single node or process is selected by the site as a leader for that purpose. In some embodiments, multiple nodes or processes are selected by the site as leader with regard to different zero-compute witnesses.

At 500, a failure detection is received. For instance, a failure detection is received from a liveness measure check module in response to a determination that a corresponding liveness measure falls outside of a liveness threshold as discussed above in regard to FIG. 4.

In response, to the liveness measure check failure detection, an attempt is made to register ownership of the resource (regardless of whether the node is currently identified as a leader or a follower). Specifically, a conditional write request is sent to the zero-compute witness. This conditional right request specifies that the requestor should be registered as the owner of the resource if no other requestor has already registered as the owner. There are multiple ways that such a request could be formed such as using a HTTP conditional write or a compare-and-swap operation. Similarly, there are any number of ways that the corresponding registration information could be maintained and a corresponding number of ways that requests could be formed. Generally, these conditions may be predicated on the lack of existence of a corresponding entry or the lack of existence of a corresponding identification of a leader in an existing entry. For example, a condition might be that no entry exists for the corresponding relationship as uniquely identified (e.g., using the corresponding resource ID and relationship ID combined to form a unique identifier). Alternatively, a condition might be that no leader is identified as the leader or the requestor is identified as the leader. In some embodiments, the registration information is maintained in separate objects for each resource or each unique combination of resources and relationships and the object(s) are named using the unique identifier thereof. In some embodiments, leadership information is registered in the zero-compute witness using a log that includes a number of key-value pairs having a combination of a unique identification of the resource and relationship(s) and a registered leader.

Regardless of the form that the conditional write request takes, the requestor determines whether the conditional write was successful at 503—e.g., in response to a success or failure message received from the remote storage having the zero-compute witness. If the conditional write was successful. The requestor will configure itself as the leader of the resource (e.g., by updating the corresponding cluster configuration) and proceed accordingly at 504. For instance, this might comprise marking the relationship as failed, and identifying the corresponding process, node, or cluster as the leader. If the conditional write failed, the requestor will configure itself as not being the leader of the resource (e.g., but updating the corresponding cluster configuration) and proceed accordingly at 506. For instance, this might comprise marking the relationship as failed, and identifying the corresponding process, node, or cluster as a follower.

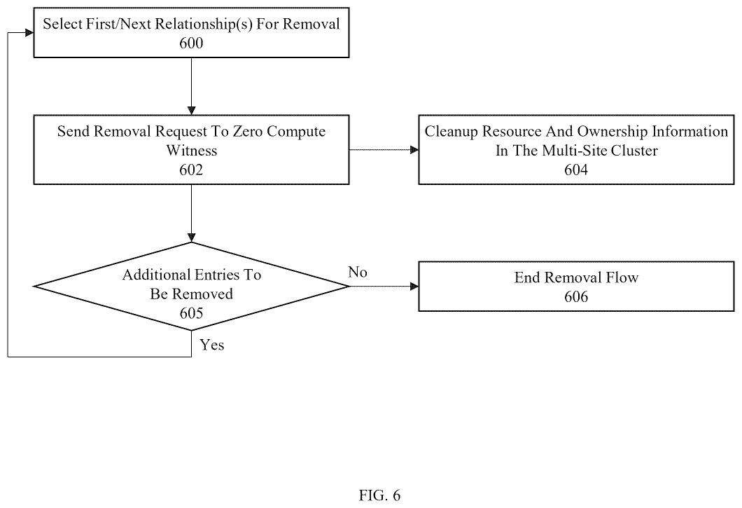

FIG. 6 illustrates a flow for removing entries that are no longer needed from the zero-compute witness according to some embodiments. Generally, this comprises deleting entries for relationships that are no longer associated with an active failure or where the failure has been resolved. In some embodiments, entries are maintained but the corresponding leader and follower information is removed. Such a process would normally be managed by a leader or owner of a resource.

For instance, the process generally starts at 600 where a first or next relationship is selected for remove. In some embodiments, this comprises identifying relationship information of a now resolved but previously existing relationship. For example, if the prior relationship was a syncRep relationship between two cluster sites for given resource, the identifier for the resource and the relationship identifier selected for removal at 600.

At 602, one or more removal requests are sent to the zero-compute witness. For instance, such a request might be conditioned on the existence of a corresponding entry, or might merely specify the removal of any entry with the corresponding unique identification information (e.g., resource ID and relationship ID). After the removal request has been sent to the zero-compute witness the process also generates one or more requests to perform cleanup operations in the multi-site cluster at 604. For example, a request might be provided to each cluster site to perform the corresponding cleanup operations on the cluster configuration information maintained therein (see e.g., 119 and 129).

At 605, the flow determines whether there are additional entries that need to be removed. For example, the process determines whether there are other removals pending processing or whether there are multiple entries in either the cluster configuration or the zero-compute witness that need to be removed. If there are additional entries to be removed the process returns to 600 where the flow then selects a next entry for processing. However, if there are not other entries for removal, the removal flow ends at 606.

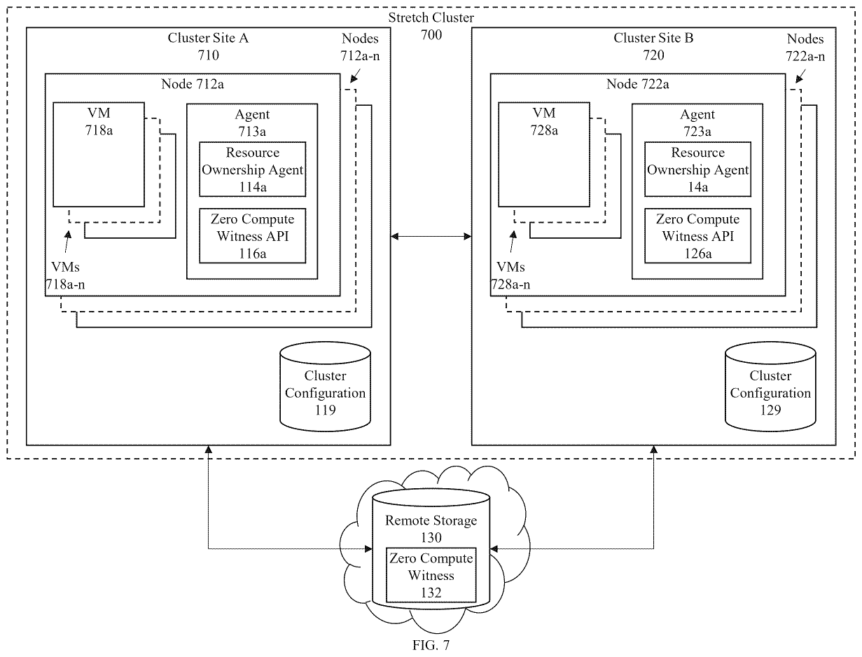

FIG. 7 depicts an environment having multiple clusters and virtual machines that are connected to each other and to a zero-compute witness according to some embodiments. Generally, the environment is similar to the one described in FIG. 1 with the description of like identified elements being applicable to like identified elements in the present figure.

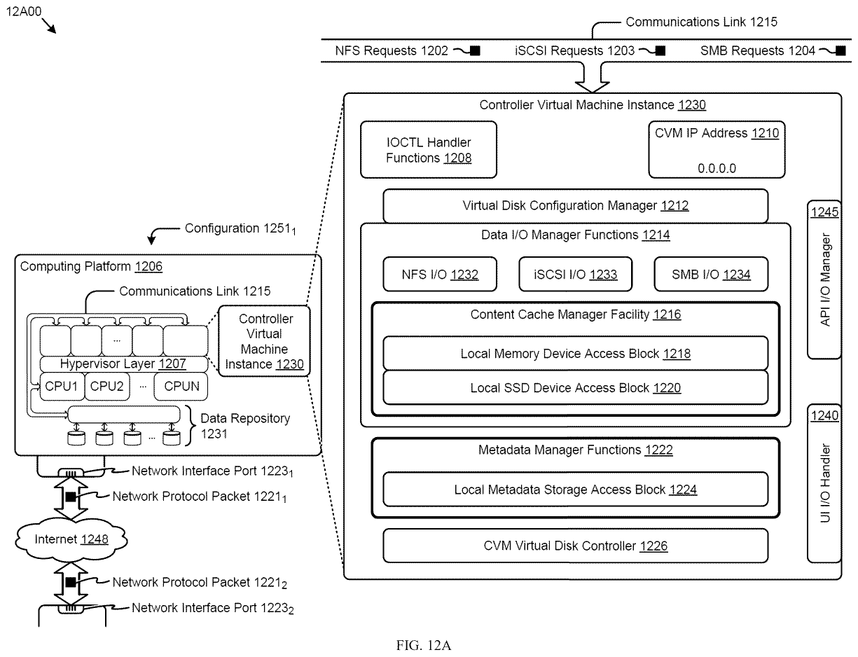

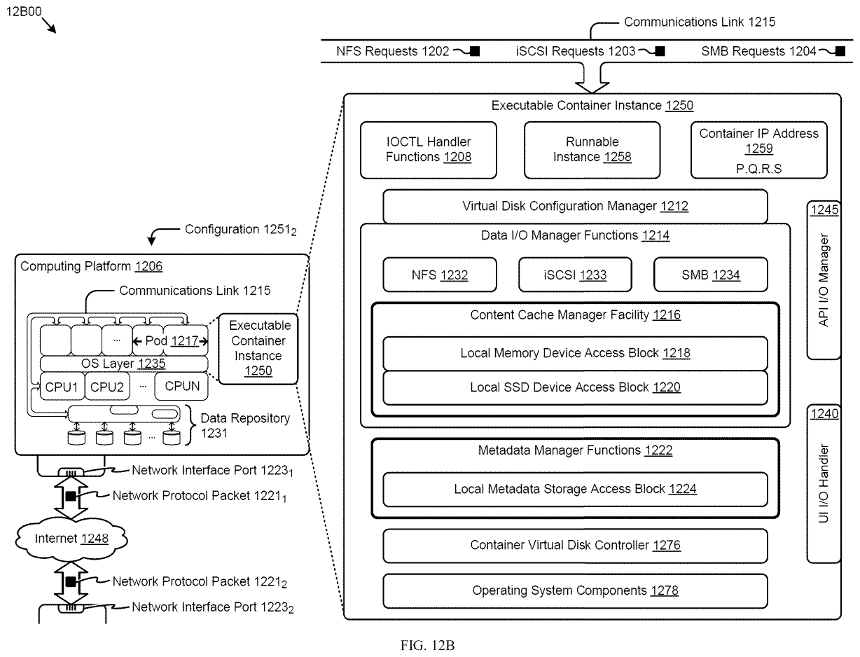

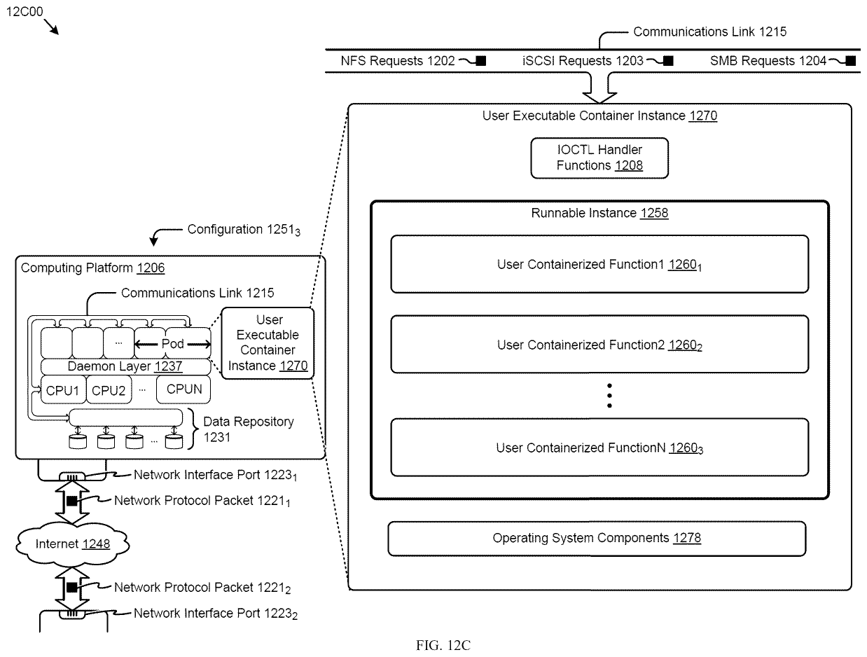

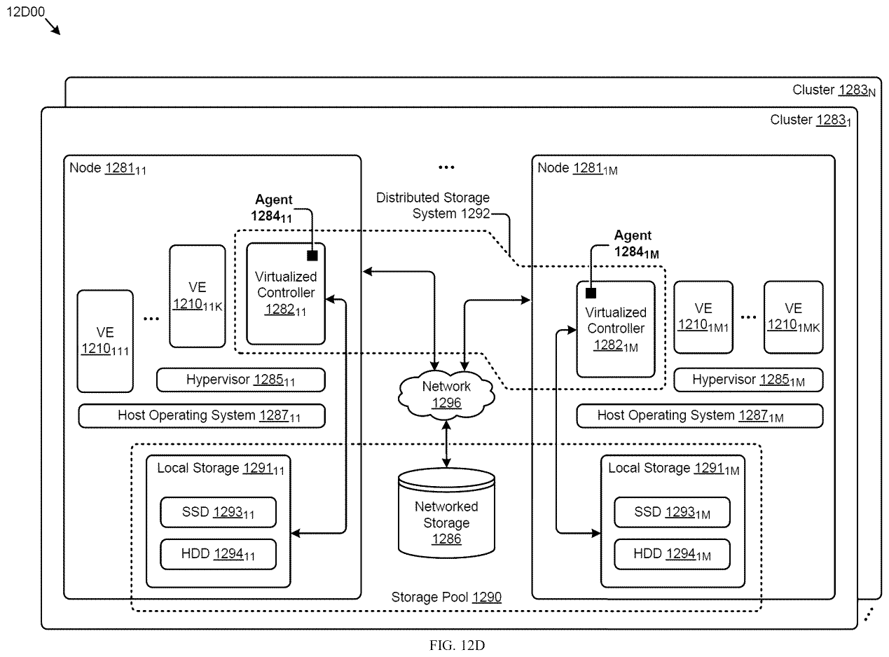

The stretch cluster 700 comprising a first cluster site A 710 and a second cluster site B (720). Each cluster site comprises cluster configuration information (see 119 and 129) any number of nodes (see e.g., nodes 712a-n and 722a-n) having one or more VMs (see e.g., 718a-n and 728a-n) and at least one node at each cluster site having an agent (see e.g., 713a and 723a) for leadership management. Additionally, each cluster site of the stretch cluster is connected to a remote storage (see e.g., 130) having a zero-compute witness (see 132). The descriptions associated with FIG. 1 are also applicable to the like identified items herein, including the cluster configurations (see 119 and 129), the resource ownership agents (see 114a and 124a), the zero-compute witness APIs (see 116a and 126a) and the remote storage (see 130) having the zero-compute witness (see 132). However, here the resource ownership agents (see 114a and 124a) and the zero-compute witness APIs (see 116a and 126a) are situated within a parent agent (see 713a and 723a). Such an agent might correspond or comprise an agent in a virtualized controller (e.g., container or virtual machine) as illustrated in FIG. 12D (see agents 108411-1M). In some embodiments, each node includes an instance of such an agent. In some embodiments, only one agent is given access rights to a particular zero-compute witness for a given cluster or site.

As illustrated, each node within a cluster site might include one or more VMs (see e.g., 718a). In some embodiments, one or more of those VMs might be configured to have a replication relationship for disaster recover purposes (e.g., a syncRep relationship) with a VM at another cluster. In some embodiments, a first cluster site (e.g., cluster site A 710) is a leader for a number of VMs having syncRep relationships with VM at a second cluster site (e.g., cluster site B 720). Likewise, in some embodiments, the second cluster site (e.g., cluster site B 720) is a leader for a number of VMs having syncRep relationships with VM at the first cluster site (e.g., cluster site A 710). Information representing said syncRep relationships might be maintained in the cluster configuration information for each cluster site for which they correspond.

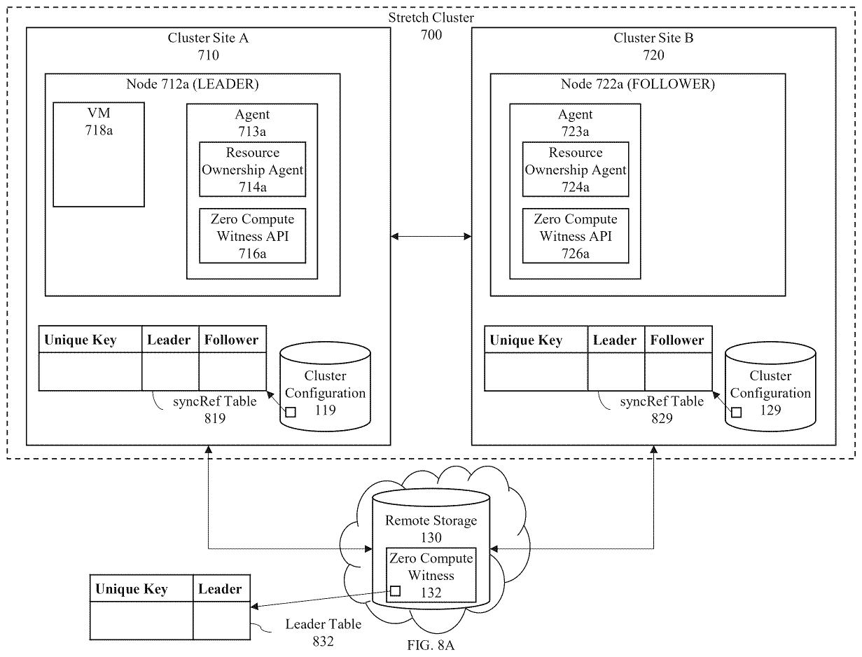

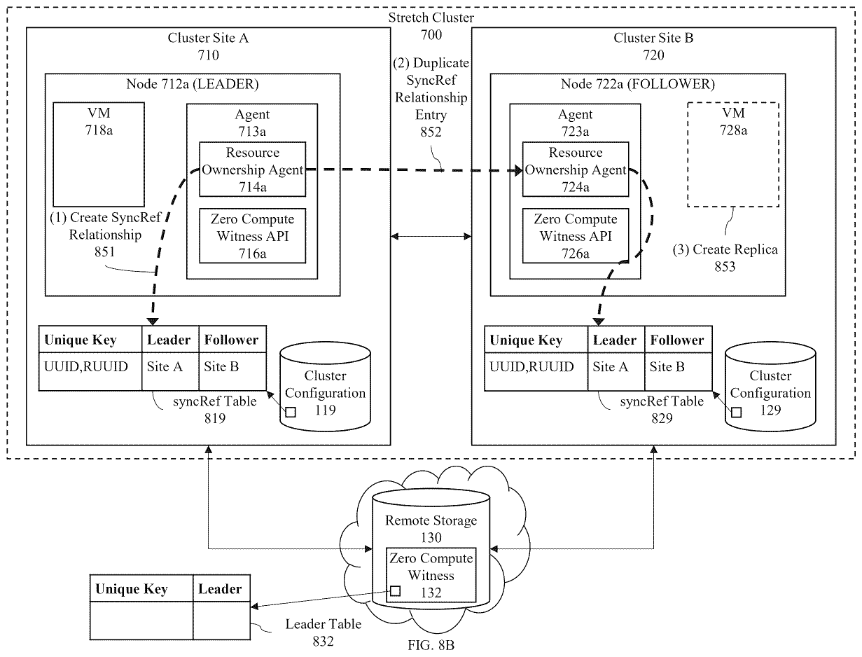

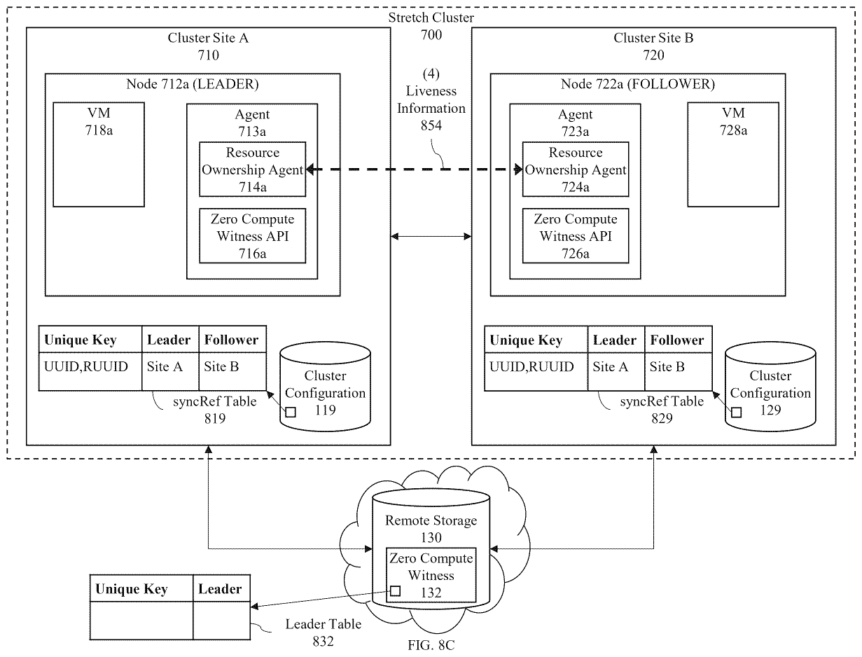

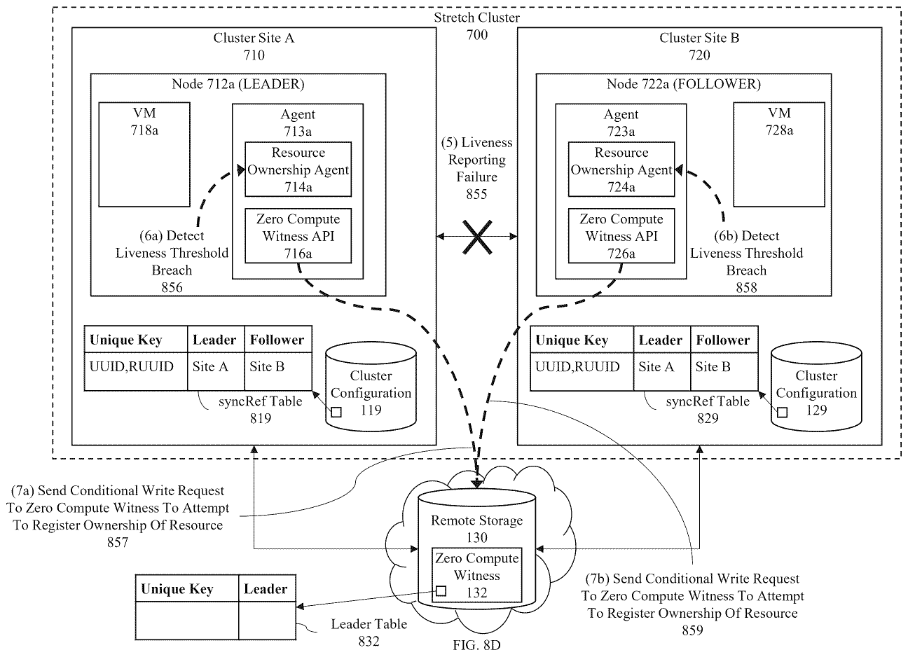

FIGS. 8A-8D depicts an example sequence of events in an environment having multiple clusters and virtual machines that are connected to each other and to a zero-compute witness according to some embodiments. Generally, the environment is that as described with like identifiers as provided herein but for the differences noted below that are intended solely to simplify the example for discussion purposes.

Specifically, FIG. 8A includes the stretch cluster 700 having a first cluster site A (see 710) and a second cluster site (see 720). However, only a single node is illustrated in each cluster (see nodes 712a and 722a). As illustrated, node 712a includes a VM 718a however, node 722a does not include an equivalent VM. In particular, the VM 718a exists only at cluster site A and does not have a syncRep relationship with cluster site B. Additionally, a syncRep table (see 819 and 829) is illustrated as being part of the cluster configurations (see 119 and 129 respectively) without any entries. Similarly, the zero-compute witness includes a leader table 832 that also does not include any entries. While each of the syncRep tables and the leader table may at any point be populated with any number of entries as needed, the present example assumes that no entries currently exist for purposes of illustration.

FIG. 8B illustrates the creation of a syncRep relationship between the two sites for the VM at site A.

Specifically, as an initial action a syncRep relationship is created at 851. Such a task might be created in response to a user configuration after the creation of the VM or as part of a preconfigured or automatic identification of the VM (e.g. 718a) for synchronous replication. Regardless of how the VM is identified for synchronous replication, configuration of the relationship may begin with a resource ownership agent creating a configuration entry in the syncRep table 819. For example, such an entry might comprise a unique key for identifying the relationship, a leader site identification, and a follower site identification. For example, the unique key might comprise a combination or concatenation of a UUID that identifies the VM (see e.g., 718A) and a RUUID that uniquely identifies the syncRep relationship. The identification of the leader and the follower for the relationship might be identified by unique site identifiers (see site A identified as the leader and site B identified as the follower.

The syncRep relationship entry is then duplicated at 852 by transmitting the syncRep information from the resource ownership agent of site A (see 714a) to the resource ownership agent of site B (see 723a). Upon receipt, the resource ownership agent creates the duplicate of the entry in a corresponding syncRep table at site B (see 829) and triggers the creation of the initial replica (see VM 728a) at 853.

FIG. 8C illustrates the exchange of liveness information between the two sites. For instance, after the initial replica of the VM has been created (see VM 728a which comprises a replica of VN 718a) each site provides periodic heart beat signals to the other to indicate that they are alive. Such signals are used to determine liveness of the members of the syncRep relationship as discussed herein and will continue to be exchange until the syncRep relationship has been removed or a failure occurs at one of the sites.

FIG. 8D illustrate detections of a liveness threshold breach and actions taken to register leadership of the relationship. As provided herein, each site performs liveness measure checks of the other. This is because the liveness measure checks serve not only as a verification that the syncRep relationship is healthy, but as a trigger to cause the registration of a site as the leader.

For example, at 855, a liveness reporting failure occurs. Such a failure might comprise a failure of the communication path between the two sites. In response, one or both sites might determine that the other has failed and attempt to register leadership. The present example illustrates an instance where both sites detect a failure. However, if the failure comprised a complete hardware or software failure at only one site (e.g., VM 718a or node 712a) the other site would be the only site to attempt to register ownership. Upon recovery, the previously failed site would recognize the failure and reconfiguration would be required to create a replacement syncRep relationship.

Specifically, as illustrated in the present figure cluster site A detects a liveness threshold breach at 856. In particular, the resource ownership agent 714a determines that the liveness measure is outside of a liveness threshold. Similarly, site B detects a liveness threshold breach at 858 using its own resource ownership agent 724a. In response to each respective liveness threshold breach determination each site sends a conditional write request to the preconfigured zero-compute witness to attempt to register ownership of the resource (see 857 and 859 respectively). In some embodiments, a single failure detection might result in multiple conditional write requests to a zero-compute witness—such as when a failure detection is associated with a node that has multiple syncRep relationships.

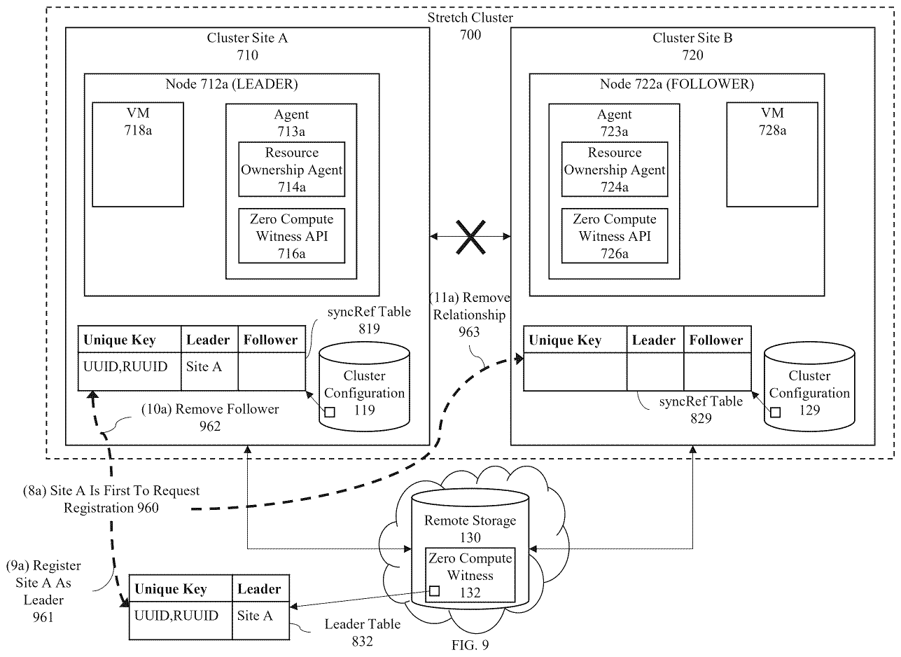

FIG. 9 continues the illustrate of FIGS. 8A-8D to illustrate a current leader witness registering ownership of the syncRep relationship according to some embodiments.

Specifically, if site A is the first to request registration (see 960) site A will be remain the leader of the syncRep relationship. This information is captured in the zero-compute witness using the same unique key that is maintained in the cluster configurations (see e.g., 819 and 829) and using at least a site ID of the leader (e.g., site A) at 961. In some embodiments, the syncRep table for the registered owner of the syncRep relationship is updated to remove the follower from the cluster configuration (see 962) or to mark the relationship as failed.

Likewise, to the extent that site B can reach the zero-compute witness and receives a failure notice for its conditional write request, site B might also update is syncRep table to remove the relationship at 963 or at least mark it as failed.

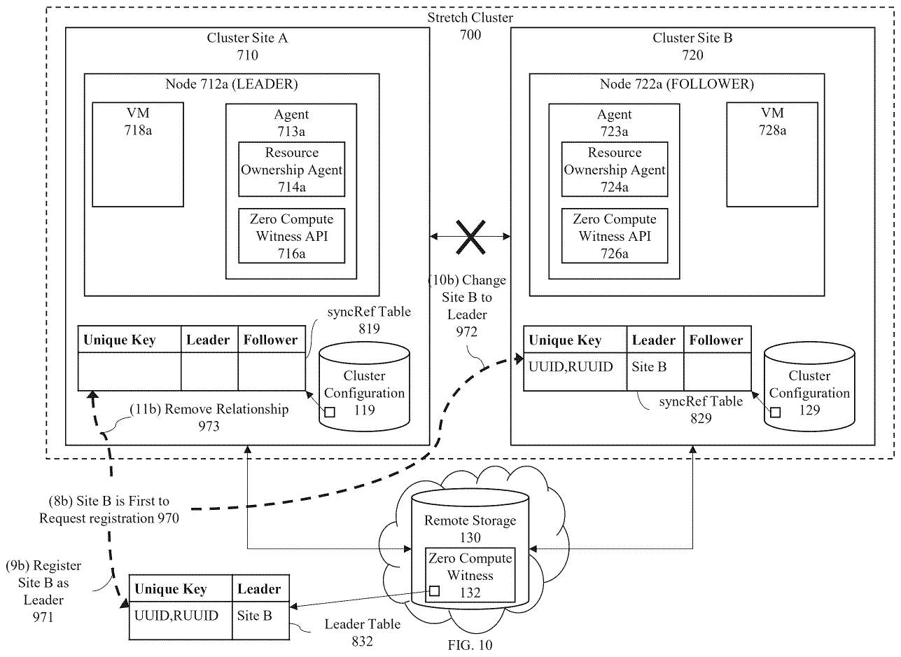

FIG. 10 continues the illustrate of FIGS. 8A-8D to illustrate a current follower witness registering ownership of the syncRep relationship according to some embodiments.

Specifically, if site B is the first to request registration (see 970) site B will become the leader of the syncRep relationship. This information is captured in the zero-compute witness using the same unique key that is maintained in the cluster configurations (see e.g., 819 and 829) and using at least a site ID of the leader (e.g., site B) at 971. In some embodiments, the syncRep table for the registered owner of the syncRep relationship is updated to remove the follower from the cluster configuration (see 972) or to mark the relationship as failed.

Likewise, to the extent that site A can reach the zero-compute witness and receives a failure notice for its conditional write request, site A might also update is syncRep table to remove the relationship at 973 or at least mark it as failed.

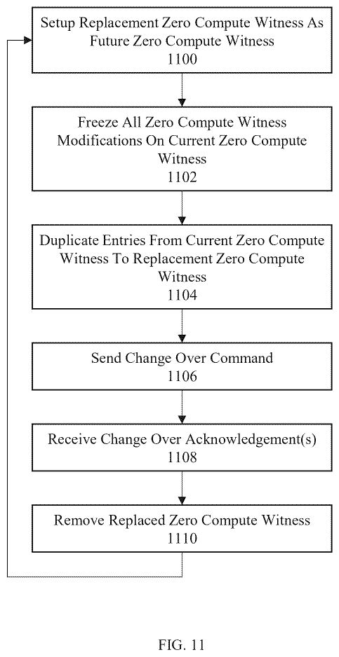

FIG. 11 illustrates a flow for migrating from one zero-compute witness to another zero-compute witness according to some embodiments. Generally, the approach comprises configuring the new zero-compute witness and the clusters to have the corresponding access information before switching over to the new-zero-compute witness.

First, a replacement zero-compute witness as a future zero-compute witness at 1100. This is generally the same as the discussed in FIG. 3 in regard to 301. However, instead of identifying the replacement zero-compute witness as the current zero-compute witness it is identified as a future zero-compute witness.

Once all the relevant locations have been setup with the replacement zero-compute witness a command is transmitted to freeze all zero-compute witness modifications for the current zero-compute witness at 1102. This is followed by duplication of any entries in the current zero-compute witness to the replacement zero-compute witness at 1104, and sending a changeover command at 1106 to configure activation of the replacement zero-compute witness as the current zero-compute witness. Once acknowledgement as been received from all the relevant locations at 1108, the now replaced zero-compute witness can be removed at 1110.

### System Architecture Overview

### Additional System Architecture Examples

All or portions of any of the foregoing techniques can be partitioned into one or more modules and instanced within, or as, or in conjunction with, a virtualized controller in a virtual computing environment. Some example instances of virtualized controllers situated within various virtual computing environments are shown and discussed as pertains to FIG. 12A, FIG. 12B, FIG. 12C, and FIG. 12D according to some embodiments.

FIG. 12A depicts a virtualized controller as implemented in the shown virtual machine architecture 12A00. The heretofore-disclosed embodiments, including variations of any virtualized controllers, can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as hypervisor layer 1207). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, computing and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system (OS) virtualization techniques are combined.

As shown, virtual machine architecture 12A00 comprises a collection of interconnected components suitable for implementing embodiments of the present disclosure and/or for use in the herein-described environments. Moreover, virtual machine architecture 12A00 includes a controller virtual machine instance 1230 in configuration 12511 that is further described below as pertaining to implementation of such a controller virtual machine instance 1230. Configuration 12511 supports virtual machine instances that are deployed as user virtual machines, or controller virtual machines or both. Such virtual machines interface with a hypervisor layer (as shown). Some virtual machines are configured to process storage inputs or outputs (I/O or IO) as received from any or every source within the computing platform. An example implementation of such a virtual machine that processes storage I/O is depicted as 1230.

In this and other configurations, a controller virtual machine instance receives block I/O storage requests as network file system (NFS) requests in the form of NFS requests 1202, and/or internet small computer system interface (iSCSI) block IO requests in the form of iSCSI requests 1203, and/or Samba file system (SMB) requests in the form of SMB requests 1204. The controller virtual machine (CVM) instance publishes and responds to an internet protocol (IP) address (e.g., CVM IP address 1210). Various forms of input and output can be handled by one or more IO control (IOCTL) handler functions (e.g., IOCTL handler functions 1208) that interface to other functions such as data IO manager functions 1214 and/or metadata manager functions 1222. As shown, the data IO manager functions can include communication with virtual disk configuration manager 1212 and/or can include direct or indirect communication with any of various block IO functions (e.g., NFS 1232, iSCSI 1233, SMB 1234, etc.).

In addition to block IO functions, configuration 12511 supports input or output (IO) of any form (e.g., block IO, streaming IO) and/or packet-based IO such as hypertext transport protocol (HTTP) traffic, etc., through either or both of a user interface (UI) handler such as UI IO handler 1240 and/or through any of a range of application programming interfaces (APIs), possibly through API IO manager 1245.

Communications link 1215 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random-access persistent memories (RAPMs) or optical or magnetic media drives such as paper tape or magnetic tape drives. Volatile media includes dynamic memory such as random-access memory. As shown, the detail of controller virtual machine instance 1230 includes content cache manager facility 1216 that accesses storage locations, possibly including local dynamic random-access memory (DRAM) (e.g., through local memory device access block 1218) and/or possibly including accesses to local solid-state storage (e.g., through local SSD device access block 1220).

Common forms of computer readable media include any non-transitory computer readable medium, for example, floppy disk, flexible disk, hard disk, magnetic tape, or any other magnetic medium; compact disk read-only memory (CD-ROM) or any other optical medium; punch cards, paper tape, or any other physical medium with patterns of holes; or any random access memory (RAM), programmable read-only memory (PROM), erasable programmable read-only memory (EPROM), flash memory EPROM (FLASH-EPROM), or any other memory chip or cartridge. Any data can be stored, for example, in any form of data repository 1231, which in turn can be formatted into any one or more storage areas, and which can comprise parameterized storage accessible by a key (e.g., a filename, a table name, a block address, an offset address, etc.). Data repository 1231 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 1224. The data repository 1231 can be configured using CVM virtual disk controller 1226, which can in turn manage any number or any configuration of virtual disks.

Execution of a sequence of instructions to practice certain embodiments of the disclosure are performed by one or more instances of a software instruction processor, or a processing element such as a central processing unit (CPU) or data processor or graphics processing unit (GPU), or such as any type or instance of a processor (e.g., CPU1, CPU2, . . . , CPUN). According to certain embodiments of the disclosure, two or more instances of configuration 12511 can be coupled by communications link 1215 (e.g., backplane, local area network, public switched telephone network, wired or wireless network, etc.) and each instance may perform respective portions of sequences of instructions as may be required to practice embodiments of the disclosure.

The shown computing platform 1206 is interconnected to the Internet 1248 through one or more network interface ports (e.g., network interface port 12231 and network interface port 12232). Configuration 12511 can be addressed through one or more network interface ports using an IP address. Any operational element within computing platform 1206 can perform sending and receiving operations using any of a range of network protocols, possibly including network protocols that send and receive packets (e.g., network protocol packet 12211 and network protocol packet 12212).

Computing platform 1206 may transmit and receive messages that can be composed of configuration data and/or any other forms of data and/or instructions organized into a data structure (e.g., communications packets). In some cases, the data structure includes program instructions (e.g., application code) communicated through the Internet 1248 and/or through any one or more instances of communications link 1215. Received program instructions may be processed and/or executed by a CPU as it is received and/or program instructions may be stored in any volatile or non-volatile storage for later execution. Program instructions can be transmitted via an upload (e.g., an upload from an access device over the Internet 1248 to computing platform 1206). Further, program instructions and/or the results of executing program instructions can be delivered to a particular user via a download (e.g., a download from computing platform 1206 over the Internet 1248 to an access device).

Configuration 12511 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (LAN) and/or through a virtual LAN (VLAN) and/or over a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to techniques to perform incremental hibernate and resume of bare metal clusters. In some embodiments, a module may include one or more state machines and/or combinational logic used to implement or facilitate the operational and/or performance characteristics pertaining to techniques to perform incremental hibernate and resume of bare metal clusters.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of techniques to perform incremental hibernate and resume of bare metal clusters). Such files or records can be brought into and/or stored in volatile or non-volatile memory.

FIG. 12B depicts a virtualized controller implemented by containerized architecture 12B00. The containerized architecture comprises a collection of interconnected components suitable for implementing embodiments of the present disclosure and/or for use in the herein-described environments. Moreover, the shown containerized architecture 12B00 includes an executable container instance 1250 in configuration 12512 that is further described below as pertaining to executable container instance 1250. Configuration 12512 includes an operating system layer (the shown OS layer 1235) that performs addressing functions such as providing access to external requestors (e.g., user virtual machines or other processes) via an IP address 1259 (e.g., “P.Q.R.S”, as shown). Providing access to external requestors can include implementing all or portions of a protocol specification, possibly including the hypertext transport protocol (HTTP or “http:”) and/or possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

An operating system layer (e.g., the shown OS layer 1235) can perform port forwarding to any executable container (e.g., executable container instance 1250). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a corresponding virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “ls”, “dir”, etc.). The executable container might optionally include operating system components 1278, however such a separate set of operating system components need not be provided. As an alternative, an executable container can include runnable instance 1258, which is built (e.g., through compilation and linking, or just-in-time compilation, etc.) to include any or all of any or all library entries and/or operating system (OS) functions, and/or OS-like functions as may be needed for execution of the runnable instance. In some cases, a runnable instance can be built with a virtual disk configuration manager, any of a variety of data IO management functions, etc. In some cases, a runnable instance includes code for, and access to, container virtual disk controller 1276. Such a container virtual disk controller can perform any of the functions that the aforementioned CVM virtual disk controller 1226 can perform, yet such a container virtual disk controller does not rely on a hypervisor or any particular host operating system so as to perform its range of functions.

In some environments, multiple executable containers can be collocated and/or can share one or more contexts. For example, multiple executable containers that share access to a virtual disk can be assembled into a pod 1217 (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod). In various implementations a pod represents a set of running or runnable processes. A pod can be deployed as the lowest level executable unit of a containerized application. As used herein, a pod that is instanced within a node can be addressed by a local IP address.

FIG. 12C depicts a virtualized controller implemented by a daemon-assisted containerized architecture 12C00. The containerized architecture comprises a collection of interconnected components suitable for implementing embodiments of the present disclosure and/or for use in the herein-described environments. Moreover, the shown daemon-assisted containerized architecture includes a user executable container instance 1270 in configuration 12513 that is further described below as pertaining to user executable container instance 1270. Configuration 12513 includes a daemon layer 1237 that performs certain functions of an operating system.

User executable container instance 1270 comprises any number of user containerized functions (e.g., user containerized function1 12601, user containerized function2 12602, . . . , user containerized functionN 12603). Such user containerized functions can execute autonomously or can be interfaced with or wrapped in a runnable object to create a runnable instance (e.g., runnable instance 1258). In some cases, the shown operating system components 1278 comprise portions of an operating system, which portions are interfaced with or included in the runnable instance and/or any user containerized functions. In this embodiment of a daemon-assisted containerized architecture, the computing platform 1206 might or might not host operating system components other than operating system components 1278. More specifically, the shown daemon might or might not host operating system components other than operating system components 1278 of user executable container instance 1270.

The virtual machine architecture 12A00 of FIG. 12A and/or the containerized architecture 12B00 of FIG. 12B and/or the daemon-assisted containerized architecture 12C00 of FIG. 12C can be used in any combination to implement a distributed platform that contains multiple servers and/or nodes that manage multiple tiers of storage where the tiers of storage might be formed using the shown data repository 1231 and/or any forms of network accessible storage. As such, the multiple tiers of storage may include storage that is accessible over communications link 1215. Such network accessible storage may include cloud storage or networked storage (NAS) and/or may include all or portions of a storage area network (SAN). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor or corresponding computer modules that manages the interactions between the underlying hardware and user virtual machines or containers that run client software.

Distinct from user virtual machines or user executable containers, a special controller virtual machine or a special controller executable container can be used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 12D depicts a distributed virtualization system in a multi-cluster environment 12D00. The shown distributed virtualization system is configured to be used to implement the herein disclosed techniques. Specifically, the distributed virtualization system of FIG. 12D comprises multiple clusters (e.g., cluster 12831, . . . , cluster 1283N) comprising multiple nodes that have multiple tiers of storage in a storage pool. Representative nodes (e.g., node 128111, . . . , node 12811M) and storage pool 1290 associated with cluster 12831 are shown. Each node can be associated with one server, multiple servers, or portions of a server. The nodes can be associated (e.g., logically and/or physically) with the clusters. As shown, the multiple tiers of storage include storage that is accessible through a network 1296, such as a networked storage 1286 (e.g., a storage area network or SAN, network attached storage or NAS, etc.). The multiple tiers of storage further include instances of local storage (e.g., local storage 129111, . . . , local storage 12911M). For example, the local storage can be within or directly attached to a server and/or appliance associated with the nodes. Such local storage can include solid state drives (SSD 129311, . . . , SSD 12931M), hard disk drives (HDD 129411, . . . , HDD 12941M), and/or other storage devices.

As shown, any of the nodes of the distributed virtualization system can implement one or more user virtualized entities (VEs) such as the virtualized entity (VE) instances shown as VE 1288111, . . . , VE 128811K, . . . , VE 12881M1, . . . , VE 12881MK, and/or a distributed virtualization system can implement one or more virtualized entities that may be embodied as virtual machines (VMs) and/or as executable containers. The VEs can be characterized as software-based computing “machines” implemented in a container-based or hypervisor-assisted virtualization environment that emulates underlying hardware resources (e.g., CPU, memory, etc.) of the nodes. For example, multiple VMs can operate on one physical machine (e.g., node host computer) running a single host operating system (e.g., host operating system 128711, . . . , host operating system 12871M), while the VMs run multiple applications on various respective guest operating systems. Such flexibility can be facilitated at least in part by a hypervisor (e.g., hypervisor instance 128511, . . . , hypervisor instance 12851M), which hypervisor instances are logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers comprise groups of processes and/or may use resources (e.g., memory, CPU, disk, etc.) that are isolated from the node host computer and other containers. Such executable containers directly interface with the kernel of the host operating system (e.g., host operating system 128711, . . . , host operating system 12871M) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any of one or more types of the foregoing virtualized controllers so as to facilitate access to storage pool 1290 by the VMs and/or the executable containers.

Multiple instances of such virtualized controllers can coordinate within a cluster to form the distributed storage system 1292 which can, among other operations, manage the storage pool 1290. This architecture further facilitates efficient scaling in multiple dimensions (e.g., in a dimension of computing power, in a dimension of storage space, in a dimension of network bandwidth, etc.).

A particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 128111 can interface with a controller virtual machine (e.g., virtualized controller 128211) through hypervisor instance 128511 to access data of storage pool 1290. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 1292. For example, a hypervisor at one node in the distributed storage system 1292 might correspond to software from a first vendor, and a hypervisor at another node in the distributed storage system 1292 might correspond to a second software vendor. As another virtualized controller implementation example, executable containers can be used to implement a virtualized controller (e.g., virtualized controller 12821M) in an operating system virtualization environment at a given node. In this case, for example, the virtualized entities at node 12811M can access the storage pool 1290 by interfacing with a controller container (e.g., virtualized controller 12821M) through hypervisor instance 12851M and/or the kernel of host operating system 12871M.

In certain embodiments, one or more instances of an agent can be implemented in the distributed storage system 1292 to facilitate the herein disclosed techniques. Specifically, agent 128411 can be implemented in the virtualized controller 128211, and agent 12841M can be implemented in the virtualized controller 12821M. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

Solutions attendant to scalable leadership election in a multi-processing computing environment using a zero-compute witness can be brought to bear through implementation of any one or more of the foregoing techniques. Moreover, any aspect or aspects of scalable leadership election in a multi-processing computing environment using a zero-compute witness can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings to be regarded in an illustrative sense rather than in a restrictive sense.

What is claimed is:

1. A non-transitory computer readable medium having stored thereon a sequence of instructions which, when executed by a processor performs a set of acts comprising:
configuring a cluster comprising a plurality of computing nodes to use a zero-compute witness in response to detection of a failure associated with a resource, wherein the zero-compute witness comprises a remote cloud-based storage object, the remote cloud-based storage object is stored at a location that is remote to the cluster and is capable of holding a value to perform witness functionality;
monitoring, by one or more nodes of the cluster, the cluster to detect the failure associated with the resource; and
in response to the detection of the failure associated with the resource, sending a conditional write request to the remote cloud-based storage object of the zero-compute witness, wherein:
in response to the remote cloud-based storage object being modified by the conditional write, a sender of the conditional write becomes an owner of the resource, and
in response to the remote cloud-based storage object not being modified by the conditional write, the sender of the conditional write does not become the owner of the resource.

2. The non-transitory computer readable medium of claim 1, wherein the cluster comprises a stretch cluster.

3. The non-transitory computer readable medium of claim 2, wherein multiple clusters are configured to use the zero-compute witness, and the multiple clusters comprise at least two or more of a compute clusters, two or more of a storage clusters, or a compute cluster and a storage cluster.

4. The non-transitory computer readable medium of claim 2, wherein the resource corresponds to a virtual machine at a first site of the stretch cluster and having a synchronous replication relationship with is a second site of the stretch cluster.

5. The non-transitory computer readable medium of claim 2, wherein the stretch cluster comprises a first site and a second site, and the first site, the second site, and the zero-compute witness are in different failure domains.

6. The non-transitory computer readable medium of claim 1, wherein ownership information is added to the remote cloud-based storage object in response to a detection of a failure only.

7. The non-transitory computer readable medium of claim 6, wherein the conditional write is predicated upon the remote cloud-based storage object not having an identification of an owner of the resource.

8. A computer-implemented method comprising:
configuring a cluster comprising a plurality of computing nodes to use a zero-compute witness in response to detection of a failure associated with a resource, wherein the zero-compute witness comprises a remote cloud-based storage object, the remote cloud-based storage object is stored at a location that is remote to the cluster and is capable of holding a value to perform witness functionality;
monitoring, by one or more nodes of the cluster, the cluster to detect the failure associated with the resource; and
in response to the detection of the failure associated with the resource, sending a conditional write request to the remote cloud-based storage object of the zero-compute witness, wherein:
in response to the remote cloud-based storage object being modified by the conditional write, a sender of the conditional write becomes an owner of the resource, and
in response to the remote cloud-based storage object not being modified by the conditional write, the sender of the conditional write does not become the owner of the resource.

9. The computer-implemented method of claim 8, wherein the cluster comprises a stretch cluster.

10. The computer-implemented method of claim 9, wherein multiple clusters are configured to use the zero-compute witness, and the multiple clusters comprise at least two or more of a compute clusters, two or more of a storage clusters, or a compute cluster and a storage cluster.

11. The computer-implemented method of claim 9, wherein the resource corresponds to a virtual machine at a first site of the stretch cluster and having a synchronous replication relationship with is a second site of the stretch cluster.

12. The computer-implemented method of claim 9, wherein the stretch cluster comprises a first site and a second site, and the first site, the second site, and the zero-compute witness are in different failure domains.

13. The computer-implemented method of claim 8, wherein ownership information is added to the remote cloud-based storage object in response to a detection of a failure only.

14. The computer-implemented method of claim 13, wherein the conditional write is predicated upon the remote cloud-based storage object not having an identification of an owner of the resource.

15. A computing system comprising:
a storage medium having stored thereon a sequence of instructions; and
a processor that executes the sequence of instructions to cause a set of acts comprising:
configuring a cluster comprising a plurality of computing nodes to use a zero-compute witness in response to detection of a failure associated with a resource, wherein the zero-compute witness comprises a remote cloud-based storage object, the remote cloud-based storage object is stored at a location that is remote to the cluster and is capable of holding a value to perform witness functionality;
monitoring, by one or more nodes of the cluster, the cluster to detect the failure associated with the resource; and
in response to the detection of the failure associated with the resource, sending a conditional write request to the remote cloud-based storage object of the zero-compute witness, wherein:
in response to the remote cloud-based storage object being modified by the conditional write, a sender of the conditional write becomes an owner of the resource, and
in response to the remote cloud-based storage object not being modified by the conditional write, the sender of the conditional write does not become the owner of the resource.

16. The computing system of claim 15, wherein the cluster comprises a stretch cluster.

17. The computing system of claim 16, wherein multiple clusters are configured to use the zero-compute witness, and the multiple clusters comprise at least two or more of a compute clusters, two or more of a storage clusters, or a compute cluster and a storage cluster.

18. The computing system of claim 16, wherein the resource corresponds to a virtual machine at a first site of the stretch cluster and having a synchronous replication relationship with is a second site of the stretch cluster.

19. The computing system of claim 16, wherein the stretch cluster comprises a first site and a second site, and the first site, the second site, and the zero-compute witness are in different failure domains.

20. The computing system of claim 15, wherein ownership information is added to the remote cloud-based storage object in response to a detection of a failure only.

21. The computing system of claim 20, wherein the conditional write is predicated upon the remote cloud-based storage object not having an identification of an owner of the resource.
